(19) United States
(12) Patent Application Publication
(10) Pub. No.: US 2008/0072333 A1
(43) Pub. Date: Mar. 20, 2008

(54) RECEIVING SYSTEMS AND RELATED METHODS STORING CONTENT PROTECTION KEYS IN CONJUNCTION WITH INFORMATION REFERRED TO MICRO-PROCESSOR

(76) Inventor: Wei-Jen Chen, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/532,916

(22) Filed: Sep. 19, 2006

(51) Int. Cl. H04L 9/32

(52) U.S. Cl. 726/27

(57) ABSTRACT

A receiving system for a multimedia data transmitted via an interface is disclosed. The receiving system includes a processor, a non-volatile storage device, and a receiver. The processor is utilized for configuring the receiving system. The non-volatile storage device, being coupled to the processor, is utilized for storing content protection keys and system information or video processing information. The receiver, being coupled to the non-volatile storage device, receives the content protection keys from the non-volatile storage device and performs a decryption operation upon the multimedia data according to the content protection keys.

### BACKGROUND

The present invention relates to a receiving system for multimedia data transmitted via an interface, and more particularly, to a receiving system for multimedia data transmitted via a High-Definition Multimedia Interface (HDMI).

Recently, HDMI has become increasingly important in modern video display systems. It is used for transmitting digital visual/audio signals from DVD players, set-up boxes, and other visual/audio sources to television sets, projectors and other video display systems. Besides carrying visual/audio data, HDMI also has a built-in content protection technology, called High-bandwidth Digital Content Protection (HDCP), for encrypting visual/audio data. In order to decrypt protected visual/audio data transmitted from an HDMI transmitter, an HDMI receiver has to get High-bandwidth Digital Content Protection (HDCP) keys during an HDCP decryption operation, where the HDCP keys are usually pre-programmed in a programmable non-volatile memory (for example, an electrically erasable programmable read only memory (EEPROM)) disposed outside the HDMI receiver. FIG. 1 is a simplified diagram of an example of a conventional receiving system 100. The conventional receiving system 100 comprises an HDMI receiver 105, a video processor 110, a processor 115, a memory 120 (e.g. a flash memory) and a programmable non-volatile memory 125 (e.g. an EEPROM). The HDMI receiver 105 receives multimedia data via Transition-Minimized Differential Signaling (TMDS) channels, performs the HDCP decryption operation by retrieving the HDCP keys from the programmable non-volatile memory 1 25, and transmits decrypted multimedia data to the video processor 110. The video processor 110 then performs video processing. The processor 115 retrieves information (e.g. system instructions and system data) from the memory 120 to configure the receiving system 100 when the receiving system 100 is powered on. Therefore, the receiving system 100 stores the HDCP keys and information referred by the processor 115 in memories 125 and 120 respectively, which requires large circuitry and complicated architecture. Even if the processor is embedded in the video processor, the programmable non-volatile memory is embedded in the HDMI receiver, or the video processor and HDMI receiver are integrated in a single chip, the cost of individually allocated memories 120, 125 cannot be reduced efficiently.

### SUMMARY

Receiving systems and related methods for multimedia data transmitted via an HDMI interface are therefore disclosed, wherein the HDCP keys and information referred by the processor are stored in a common storage device.

In some embodiments, a receiving system comprises a processor for configuring the receiving system, a non-volatile storage device for storing content protection keys and information referred to by the processor, for example, the system codes for configuring the receiving system, and a receiver for receiving the content protection keys outputted from the non-volatile storage device and performing a decryption operation upon the multimedia data according to the content protection keys. The non-volatile storage device can be any existed memory in the system for storing system codes or video processing data

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram of a related art receiving system.

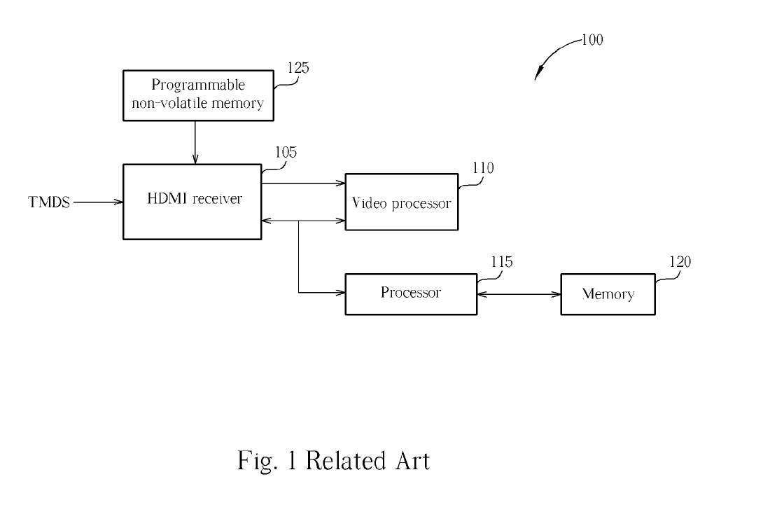

FIG. 2 is a diagram of a receiving system according to a first embodiment of the present invention.

FIG. 3 is a diagram of a receiving system according to a second embodiment of the present invention.

FIG. 4 is a diagram of a receiving system according to a third embodiment of the present invention.

FIG. 5 is a diagram of a receiving system according to a fifth embodiment of the present invention.

FIG. 6 is a diagram of a receiving system according to a sixth embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

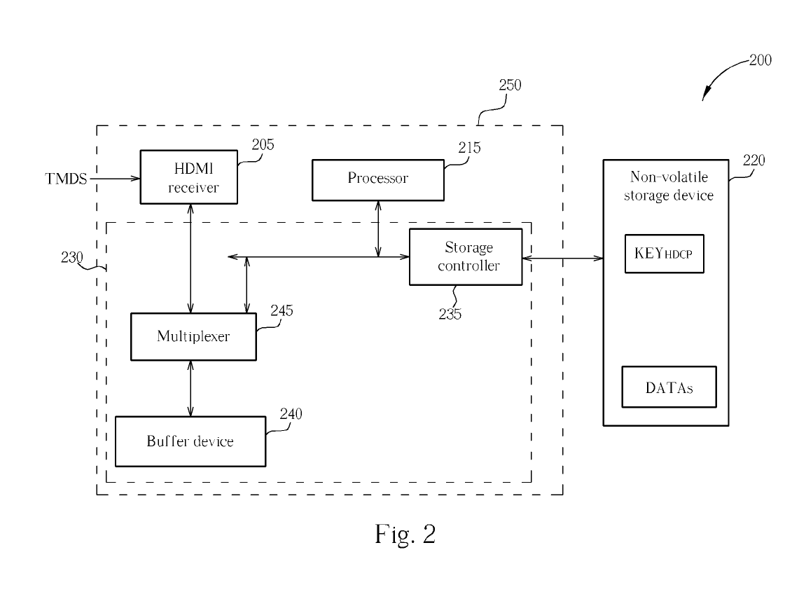

FIG. 2 is a diagram of a receiving system 200 according to a first embodiment of the present invention. The receiving system 200 comprises an HDMI receiver 205 capable of receiving incoming multimedia data via TMDS channels, a processor 215, a non-volatile storage device 220 (e.g. a flash memory), and an HDMI key accessing apparatus 230. The processor 215 may comprise a central processing unit (CPU), a micro-controller, or any computing unit. The HDMI key accessing apparatus 230 comprises a storage controller 235 (e.g. a flash controller), a buffer device 240, and a multiplexer 245. In this embodiment, the HDMI receiver 205 and the video processor are integrated in a single integrated circuit (i.e. a single chip) 250. This one-chip-configuration is not meant to be taken as a limitation of the present invention. The HDMI key accessing apparatus 230 buffers the HDCP keys KEY_{HDCP} in the buffer device 240 read from the non-volatile storage device 220 via the storage controller 235, and transmits the buffered HDCP keys KEY_{HDCP} to the HDMI receiver 205 in response to a request from the HDMI receiver 205. The non-volatile storage device 220 stores the HDCP keys KEY_{HDCP}, CPU instructions, and system information DATA_{S}. The buffer device 240 may be implemented with a static random access memory (SRAM). After the system boots up, the processor 215 moves a copy of the HDCP keys KEY_{HDCP} from the non-volatile storage device 220 to the buffer device 240 via the storage controller 235 and multiplexer 245. After the HDCP keys KEY_{HDCP} is copied to the buffer device 240, the multiplexer 245 will be switched to connect the buffer device 240 and the HDMI receiver 205. During the HDCP decryption operation, an HDCP decryption engine in the HDMI receiver 205 can access the HDCP keys KEY_{HDCP} from the on-chip buffer device 240.

In some embodiments, the HDMI receiver has the flexibility to acquire the HDCP keys from either the internal buffer device or external storage device (such as an EEPROM). For example, the HDMI receiver acquires the HDCP keys through an inter-integrated circuit (I²C) interface, where the external storage device is coupled to an I²C pin of the receiver system integrated circuit through an I²C bus, and the internal buffer device is couple to the HDMI receiver via an I²C slave port.

Furthermore, in some other embodiments, the HDMI receiver 205 and the video processor are implemented in individual integrated circuits. The HDMI receiver 205 may retrieve the HDCP keys KEY_{HDCP} from the buffer device 240 via the multiplexer 245 and an I²C interface. Other transmission protocols such as serial protocol interface (SPI) and universal serial bus (USB) are also alternatives for the transmission between two ICs.

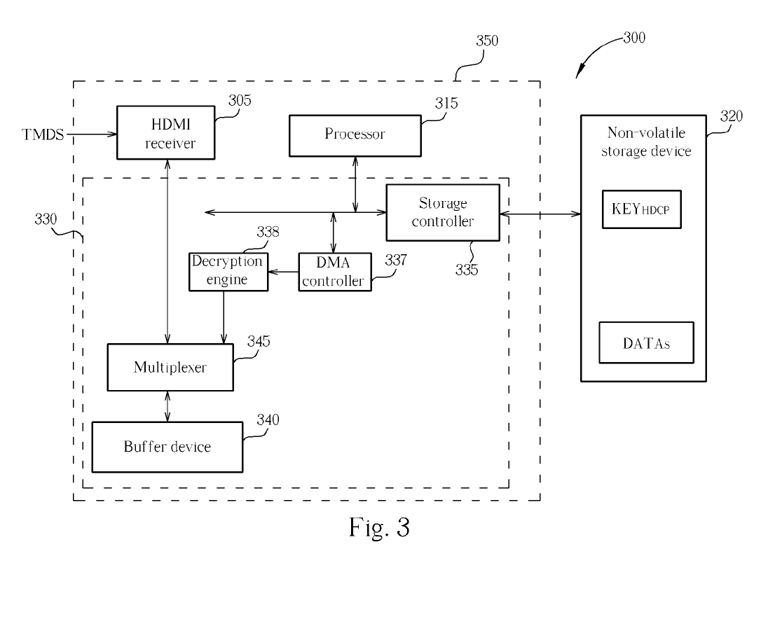

FIG. 3 is a diagram of a receiving system 300 according to a second embodiment. The receiving system 300 comprises an HDMI receiver 305 capable of receiving incoming multimedia data via TMDS channels, a processor 315, a non-volatile storage device 320 (e.g. a flash memory) storing an HDCP keys KEY_{HDCP} and system information DATAs referred to by the processor 315, and an HDMI key accessing apparatus 330. The HDMI key accessing apparatus 330 comprises a storage controller 335 (e.g. a flash controller), a direct memory access (DMA) controller 337, a decryption engine 338, a buffer device 340, and a multiplexer 345. Please note that, in this embodiment, the HDCP keys KEY_{HDCP} stored in the non-volatile storage device 320 are encrypted HDCP keys. The HDMI receiver 305, processor 315, HDMI key accessing apparatus 330, and video processor are all integrated in a single integrated circuit 350. However, encrypted keys or single IC are not meant to be taken as limitations of the present invention.

As is well known by one skilled in the art, the DMA mode is activated to transfer data efficiently because no CPU intervention occurs. The processor 315 can be released to execute other operations. The DMA controller 337 obtains the encrypted HDCP keys from the non-volatile storage device 320 to the decryption engine 338 for decryption to generate decrypted HDCP keys. The decrypted HDCP keys will be buffered in the buffer device 340 and acquired by the HDMI receiver 305 for performing the decryption operation upon the multimedia data. In addition, the HDMI key accessing apparatus 330 can also be designed to buffer the HDCP keys KEY_{HDCP} read from the non-volatile storage device 320 automatically during a boot-up process of the receiving system 300.

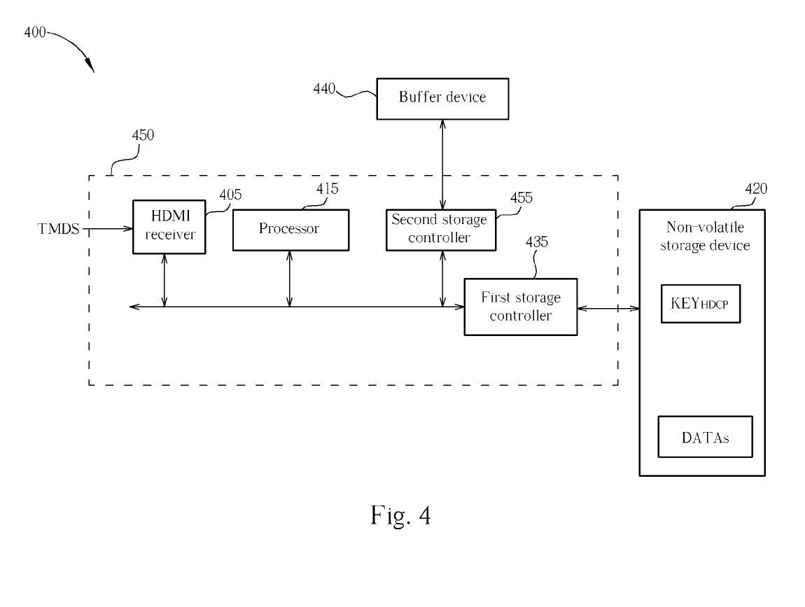

FIG. 4 is a diagram of a receiving system 400 according to a third embodiment, the receiving system 400 comprises an HDMI receiver and video processor integrated circuit, a non-volatile storage device 420 (e.g. a flash memory) storing HDCP keys KEY_{HDCP} and system information DATA_{S}, and a buffer device (e.g. a DRAM) 440. The HDMI receiver and video processor IC comprises an HDMI receiver 405, a processor 415, a first storage controller 435 (e.g. a flash controller), and a second storage controller (e.g. a DRAM controller) 455. The HDMI receiver 405 processor and the video processor are integrated in a single IC 450 in this embodiment, however, this circuitry architecture is not meant to be taken as a limitation of the present invention. Generally speaking, a video display system requires at least a DRAM to store video/audio processing data and CPU instructions. The buffer device 440 (i.e. a DRAM) can be used to buffer the HDCP keys copied from the non-volatile storage device 420 at boot time. The HDMI receiver 405 can access the HDCP keys KEY_{HDCP} from the buffer device 440 directly through the second storage controller 455. In this embodiment, the buffer device 440 is not specified for buffering the HDCP keys KEY_{HDCP} only. For example, the buffer device 440 can be a video frame buffer storing video processing data accessed by the video processor.

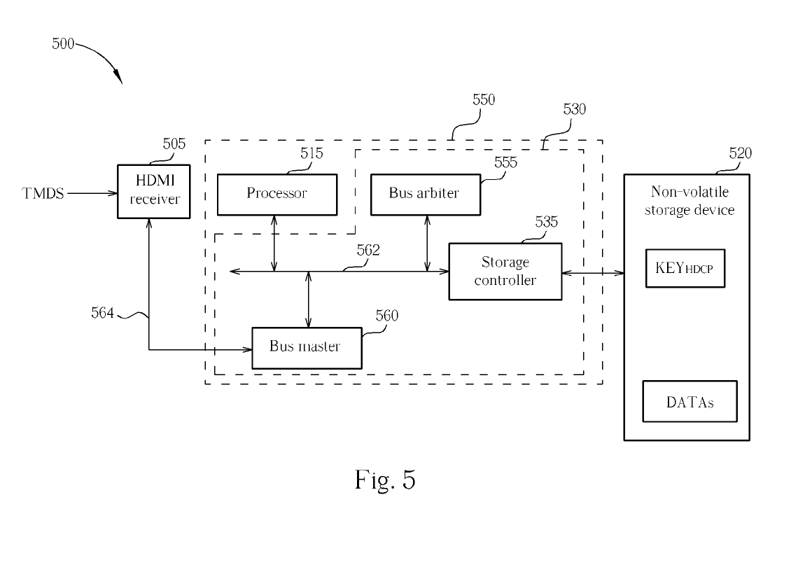

FIG. 5 shows another embodiment of implementing the HDMI receiver and video processor on different ICs, the receiving system 500 comprises an HDMI receiver 505, a video processor 550, and a non-volatile storage device 520 (e.g. a flash memory) storing both the HDCP keys KEY_{HDCP} and system information DATA_{S}. In this embodiment, a buffer device (such as 240, 340, 440) may be eliminated since the HDMI receiver may access the HDCP keys from the non-volatile storage device 520 directly. The video processor 550 comprises a processor 515 and an HDMI key accessing apparatus 530. The HDMI key accessing apparatus 530 comprises a storage controller 535, a bus arbiter 555, and a bus master 560. The bus arbiter 555 selects either the processor 515 or the bus master 560 to get the bus authority to transmit/receive data or HDCP keys via a system bus 562 inside the video processor 550. If the bus master 560 gets the bus authority, a copy of the HDCP keys KEY_{HDCP} stored in the non-volatile storage device 520 will be transmitted to the HDMI receiver 505 via the storage controller 535, the system bus 562, and an I²C bus 564. An I²C slave port may be aided to transmit the HDCP keys between the HDMI receiver IC 505 and video processor IC 550. If the processor 515 gets the bus authority, system instructions (i.e. the system information DATA_{S}) will be transmitted from the non-volatile storage device 520 to the processor 515 for processing.

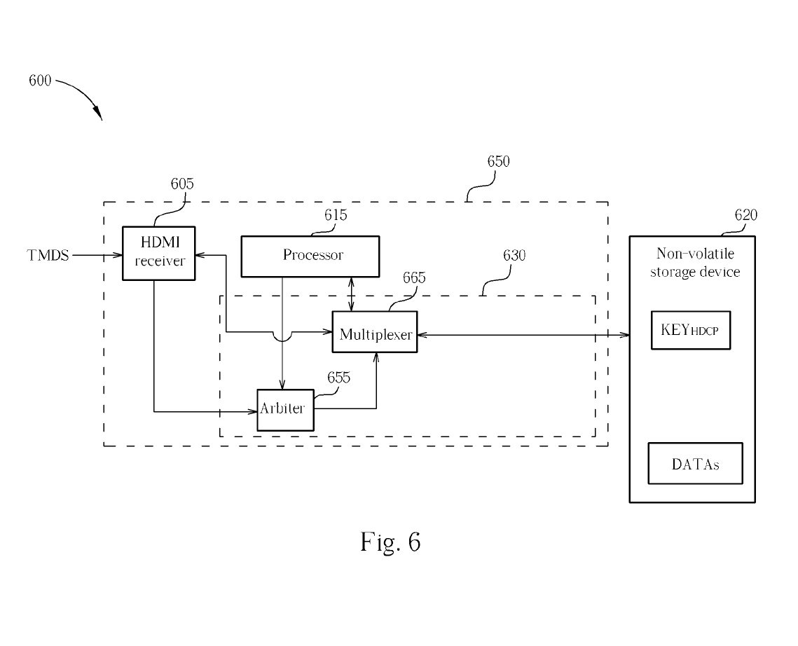

FIG. 6 is a diagram of a receiving system 600 according to a sixth embodiment, the receiving system 600 comprises a HDMI receiver 605 capable of receiving incoming multimedia data via TMDS channels, a processor 615, a non-volatile storage device 620 (e.g. a system flash memory) storing HDCP keys KEY_{HDCP} and system information DATA_{S}, and an HDMI key accessing apparatus 630. The HDMI key accessing apparatus 630 comprises an arbiter 655, and a multiplexer 665. The HDMI receiver 605 or the processor 615 can access the non-volatile storage device 620 by issuing a request to the arbiter 655 to obtain authority. The arbiter 655 generates a selection signal to control the multiplexer 665 to arbitrate authority of accessing the non-volatile storage device 620 between the HDMI receiver 605 and the processor 615, where the HDMI receiver 605 reads the HDCP keys KEY_{HDCP} from the non-volatile storage device 620 when obtaining authority, on the other hand, the processor 615 reads system information DATA_{S} (e.g. system instructions) from the non-volatile storage device 620 when obtaining authority.

In the above embodiments, by storing the HDCP keys and information together in the non-volatile storage device, a dedicated storage device (such as an internal SRAM) can be saved and therefore the production cost of the receiving system will be greatly reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A receiving system for a multimedia data transmitted via an interface, the receiving system comprising:
a processor, configuring the receiving system;
a non-volatile storage device, coupled to the processor, storing content protection keys and information referred to by the processor to configure the receiving system; and
a receiver, coupled to the non-volatile storage device, receiving the content protection keys outputted from the non-volatile storage device and performing a decryption operation upon the multimedia data according to the content protection keys.

2. The receiving system of claim 1, wherein the interface is a High-Definition Multimedia Interface (HDMI), the receiver is an HDMI receiver, and the content protection keys are HDCP keys.

3. The receiving system of claim 2, further comprising:
an HDMI key accessing apparatus, coupled to the HDMI receiver and the non-volatile storage device, for buffering the HDCP keys read from the non-volatile storage device, and then transmitting the buffered HDCP keys to the HDMI receiver in response to a request from the HDMI receiver.

4. The receiving system of claim 3, wherein the HDMI key accessing apparatus buffers the HDCP keys read from the non-volatile storage device during a boot-up process of the receiving system.

5. The receiving system of claim 3, wherein the HDMI key accessing apparatus comprises:
a storage controller, coupled to the non-volatile storage device, for controlling data access of the non-volatile storage device;
a buffer device; and
a multiplexer, coupled to the storage controller, the HDMI receiver, and the buffer device, for selectively allowing the storage controller or the HDMI receiver to access the buffer device, wherein the HDCP keys are sent to the buffer device via the multiplexer, and the HDMI receiver retrieves the HDCP keys buffered in the buffer device via the multiplexer.

6. The receiving system of claim 5, wherein the HDCP keys stored in the non-volatile storage device are encrypted HDCP keys, and the processor is further coupled to the multiplexer and the storage controller for decrypting the encrypted HDCP keys read from the non-volatile storage device to generate decrypted HDCP keys and stores the decrypted HDCP keys into the buffer device.

7. The receiving system of claim 5, wherein the HDMI key accessing apparatus further comprises:
a direct memory access (DMA) controller, coupled between the multiplexer and the storage controller, for moving the HDCP keys from the non-volatile storage device to the buffer device via the multiplexer.

8. The receiving system of claim 7, wherein the HDCP keys stored in the non-volatile storage device are encrypted HDCP keys, and the HDMI key accessing apparatus further comprises:
a decryption engine, coupled to the DMA controller and the multiplexer, for decrypting the encrypted HDCP keys read from the non-volatile storage device via the DMA controller to generate decrypted HDCP keys and stores the decrypted HDCP keys into the buffer device via the multiplexer.

9. The receiving system of claim 5, wherein the buffer device is specified for buffering the HDCP keys only.

10. The receiving system of claim 2, wherein the processor is positioned in a first integrated circuit for video processing, and the HDMI receiver is positioned in a second integrated circuit.

11. The receiving system of claim 10, wherein the first integrated circuit further comprises:
a storage controller, coupled to the non-volatile storage device, controlling data access of the non-volatile storage device;
a buffer device, buffering the HDCP keys retrieved from the non-volatile storage device through the storage controller;
a transmission port, coupled to the HDMI receiver, for the HDMI receiver to access the HDCP keys from the buffer device in the first integrated circuit; and
a multiplexer, coupled to the storage controller, the buffer device, and the transmission port, for selectively allowing the storage controller or the HDMI receiver to access the buffer device, wherein the HDCP keys are sent to the buffer device via the multiplexer, and the HDMI receiver retrieves the HDCP keys buffered in the buffer device via the multiplexer.

12. The receiving system of claim 11, wherein the transmission port is selecting from one of an I2C slave port, a serial protocol interface (SPI) port, or an universal serial bus (USB) port.

13. The receiving system of claim 10, wherein the first integrated circuit further comprises:
a storage controller, coupled to the non-volatile storage device, controlling data access of the non-volatile storage device;
a bus master, getting bus authority for the HDMI receiver to access the HDCP keys from the non-volatile storage device directly;
a bus arbiter, arbitrating bus authority between the processor and the bus master; and
a transmission port, coupled to the HDMI receiver, aiding transmission of the HDCP keys between the HDMI receiver and the first integrated circuit.

14. The receiving system of claim 3, wherein the processor, the HDMI key accessing apparatus, and the HDMI receiver are positioned in a single integrated circuit.

15. The receiving system of claim 3, wherein the HDMI key accessing apparatus comprises:
a first storage controller, coupled to the non-volatile storage device, controlling data access of the non-volatile storage device;
a buffer device, not specified for buffering the HDCP keys only; and
a second storage controller, coupled to the buffer device and the first storage controller, controlling data access of the buffer device, wherein the HDCP keys are read from the non-volatile storage device and buffered into the buffer device via the first and second storage controllers.

16. The receiving system of claim 2, further comprising:
an HDMI key accessing apparatus, coupled to the HDMI receiver and the non-volatile storage device, for directly transmitting the HDCP keys in the non-volatile storage device to the HDMI receiver in response to a request from the HDMI receiver.

17. The receiving system of claim 16, wherein the HDMI key accessing apparatus comprises:
a multiplexer, coupled to the non-volatile storage device, the processor, and the HDMI receiver, allowing one of the processor or the HDMI receiver to access the non-volatile storage device at a time according to a selection signal; and
an arbiter, coupled to the HDMI receiver and the processor, generating the selection signal to arbitrate authority of accessing the non-volatile storage device between the HDMI receiver and the processor, where the HDMI receiver reads the HDCP keys in the non-volatile storage device when getting authority of accessing the non-volatile storage device from the arbiter.

18. A method for transmitting a multimedia data via an interface, comprising:
configuring a receiving system;
storing content protection keys and information referred to configure the receiving system together in a non-volatile storage device; and
receiving the content protection keys outputted from the non-volatile storage device and performing a decryption operation upon the multimedia data according to the content protection keys.

19. The method of claim 18, wherein the interface is a High-Definition Multimedia Interface (HDMI) and the content protection keys are HDCP keys.

20. The method of claim 19, further comprising:
buffering the HDCP keys read from the non-volatile storage device and transmitting the buffered HDCP keys in response to a request of receiving the HDCP keys.

21. The method of claim 20, wherein the step of buffering the HDCP keys read from the non-volatile storage device comprises:
buffering the HDCP keys read from the non-volatile storage device during a boot-up process of the receiving system.

22. The method of claim 20, wherein the step of buffering the HDCP keys read from the non-volatile storage device and transmitting the buffered HDCP keys comprises:
controlling data access of the non-volatile storage device;
providing a buffer device; and
selectively accessing the buffer device, wherein the HDCP keys are sent to the buffer device by controlling data access of the non-volatile storage device and the HDCP keys is then transmitted in response to the request of receiving the HDCP keys.

23. The method of claim 22, wherein the HDCP keys stored in the non-volatile storage device are encrypted HDCP keys, and the step of configuring the receiving system comprises:
decrypting the encrypted HDCP keys read from the non-volatile storage device to generate decrypted HDCP keys and stores the decrypted HDCP keys into the buffer device.

24. The method of claim 22, wherein the step of buffering the HDCP keys read from the non-volatile storage device and transmitting the buffered HDCP keys further comprises:
moving the HDCP keys from the non-volatile storage device to the buffer device according to a direct memory access (DMA) operation.

25. The method of claim 24, wherein the HDCP keys stored in the non-volatile storage device are encrypted HDCP keys, and the step of buffering the HDCP keys read from the non-volatile storage device and transmitting the buffered HDCP keys further comprises:
decrypting the encrypted HDCP keys read from the non-volatile storage device to generate decrypted HDCP keys and stores the decrypted HDCP keys into the buffer device after the DMA operation.

26. The method of claim 22, wherein the buffer device is specified for buffering the HDCP keys only.

27. The method of claim 19, further comprising:
controlling data access of the non-volatile storage device;
providing a buffer device, and utilizing the buffer device for buffering the HDCP keys retrieved from the non-volatile storage device;
providing a transmission port, and utilizing the transmission port to access the HDCP keys from the buffer device; and
selectively accessing the buffer device by transmitting the HDCP keys into the buffer device or by retrieving the HDCP keys buffered in the buffer device.

28. The method of claim 27, wherein the transmission port is selecting from one of an I2C slave port, a serial protocol interface (SPI) port, or an universal serial bus (USB) port.

29. The method of claim 19, further comprising:
controlling data access of the non-volatile storage device;
getting bus authority for receiving the HDCP keys outputted from the non-volatile storage device directly;
arbitrating bus authority between configuring the receiving system and receiving the HDCP keys outputted from the non-volatile storage device directly; and
providing a transmission port, and utilizing the transmission port to aid transmission of the HDCP keys.

30. The method of claim 20, wherein the step of buffering the HDCP keys read from the non-volatile storage device and transmitting the buffered HDCP keys comprises:
controlling data access of the non-volatile storage device;
providing a buffer device, not specified for buffering the HDCP keys only; and
controlling data access of the buffer device; and
wherein the HDCP keys are read from the non-volatile storage device by controlling data access of the non-volatile storage device,
and the HDCP keys are buffered into the buffer device by controlling data access of the buffer device.

31. The method of claim 19, further comprising:
directly transmitting the HDCP keys in the non-volatile storage device in response to a request of receiving the HDCP keys.

32. The method of claim 31, wherein the step of directly transmitting the HDCP keys in the non-volatile storage device comprises:
selectively configuring the receiving system or receiving the HDCP keys to access the non-volatile storage device at a time according to a selection signal; and
generating the selection signal to arbitrate authority of accessing the non-volatile storage device.
